(19) United States
(12) Patent Application Publication
(10) Pub. No.: US 2006/0167768 A1
(43) Pub. Date: Jul. 27, 2006

(54) Method and system for facilitating reseller transactions

(76) Inventors: Steven J. Sculler, Morganville, NJ (US); Mitchell L. Stevelman, Ringwood, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/386,854

(22) Filed: Mar. 22, 2006

Related U.S. Application Data
(62) Division of application No. 09/677,153, filed on Oct. 2, 2000.
Application No. 09/677,153 is a continuation-in-part of application No. 09/658,977, filed on Sep. 11, 2000, now Pat. No. 6,901,376.
(60) Provisional application No. 60/214,632, filed on Jun. 28, 2000.
(60) Provisional application No. 60/153,183, filed on Sep. 10, 1999.

(51) Int. Cl. G06Q 30/00

(52) U.S. Cl. 705/26

(57) ABSTRACT

A computer-implemented method and system is provided which displays lists of products including personalization information and further allows the locking of aspects of personalization information.

### CROSS-REFERENCE TO RELATED APPLICATION

This application is a divisional of U.S. application Ser. No. 09/677,153, filed on Oct. 2, 2000, which is a continuation-in-part of U.S. patent application Ser. No. 09/658,977 filed Sep. 11, 2000 listing the same inventors which in turn claimed the benefit of U.S. Provisional Patent Application Nos. 60/214,632, filed Jun. 28, 2000, and 60/153,183, filed Sep. 10, 1999, listing the same inventors. The disclosure of all of the foregoing applications are hereby incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Computerized systems have long been used in connection with the ordering and selling of products and services. However, typically, the systems are designed to handle a single level in any channel of trade. For example, a web site may have product-ordering software which allows the consumer to order products on-line. In turn, the seller will typically use a different computer program to order products from its own vendors. The vendors, in turn, may have their own suppliers who also have there own product-ordering software.

While some companies may optimize their databases so that they can automatically generate purchase orders based upon automated customer requests, such software often needs to overcome the different formats required by the different software programs. The inefficiencies of such a system is increased by the fact that each entity will have its own separate product ordering and supply ordering software, with the concomitant need to convert their data from one format to another.

The disadvantages of such prior art systems are particularly manifest in products that contain personalized information, such as the typesetting associated with the impression of a stamp. Typically a customer will call or fax in an order. The reseller will write down the information and then typeset it or pass it on to another manufacturer. Thus, the image is sent up the chain of distribution until it finally reaches the company that makes the part containing the typesetting. Each of these steps leads to possible errors in the personalization. The image might go through many conversions, be it from paper to facsimile to one electronic format to another electronic form. Each conversion or handling by an intermediary entity increases the possibility of error.

Accordingly, there is a need for a centralized system serving the needs of multiple entities across a particular channel of trade which can automatically generate customer and supply orders in response to customer requests. There is a further need for a system which can resolve the accuracies inherent in ordering personalized products.

### SUMMARY OF THE INVENTION

The invention is directed to those needs.

One embodiment of the invention provides a computer-implemented method of retrieving product distribution information. One step includes storing first and second relationship information. Relationship information identifies a buyer, a seller and a product to be provided from the seller to the buyer. The first relationship information identifies a first entity as the buyer, a second entity as the seller, and a first product as the product. The second relationship information identifies the second entity as the buyer, a third entity as the seller and the first product as the product.

Other steps include retrieving the first relationship information and then retrieving the second relationship information. The second relationship information is retrieved based on the identity of the seller and the identity of the product contained in the first relationship information.

Preferably, the method also includes storing and retrieving third relationship information, where third relationship information identifies the third entity as the buyer and yet another entity, the fourth entity as the seller. The third relationship information also identifies the product.

In one aspect, the first product is a part of a second product, and the first relationship identifies a product containing the part.

Desirably, the relationship information includes the compensation which the seller agrees to accept for the product from the buyer. The compensation may be the price of the product or a commission.

It is not necessary for the first entity to represent only a single company or person. Rather, the first entity identified by the first relationship may be a class of entities, such as the general public. The step of retrieving the first relationship information may include displaying to the first entity at least two products associated with those relationships identifying the first entity as the buyer. The first relationship information is retrieved based upon the product selected by the particular member of the class.

Advantageously, the method includes the step of storing a description of the product. The may be an image, a textual description, or an image and a textual description.

It is also preferable for the method to include the step of the first entity requesting the first product from the second entity and storing the request. A request for the first product by the second entity to the third entity is also stored based on the second relationship information that was retrieved. The third entity may be notified of the request, and the request may include the quantity and shipping destination(s) of the product.

The step of retrieving the second relationship information may comprise searching for relationships for wherever the buyer of the relationships being searched identifies the seller of the first relationship, and the product of the relationships being searched identifies the product of the first relationship.

Desirably, the method also includes the steps of storing additional relationships associated with the product and repeating the step of retrieving the second relationship. The step is repeated by recursively assuming that some of the values of the first relationship are equal to the values of the second relationship. The repeating step terminates when there is no relationship identifying the seller of the second relationship as a buyer of the same product in another relationship.

Another embodiment of the invention comprises a computer-implemented method of providing information about a product including typesetting. The method includes storing data representing (a) a typesetting-related product that is available from a first member to a class of customers the product including typesetting and (b) an agreement by a second member to provide the product to the first member. The method further includes receiving a request for the product from a customer of the class whereby the request includes information describing the typesetting. The customer request is stored and the agreement is retrieved based on the identity of the product and the first member associated with the customer's request. A second request is then generated whereby the second member is requested to provide the product to the first member. The second request also identifies the typesetting information. The second request is then transmitted to the second member.

The class of customers may actually include only a single entity.

Preferably, the method further includes storing data representing an agreement by a third member to provide the product to the second member. This agreement is retrieved based on the identity of the product and the identity of the second member.

The typesetting information may comprise an image. In one aspect, a plurality of requests are received from a plurality of customers in the class and the image associated with one customer's request is different from the image associated with another customer's request. When the customer requests are stored, the different images may be stored in the same file format or different file formats. The method may include the steps of (a) converting the image from the stored file format to a different file format and then (b) the second member retrieving the image. If the images are stored in different file formats, the stored file formats are preferably stored in formats corresponding with the file formats used by the members.

In another aspect, the product is a stamp, the typesetting relates to the impression on the stamp, and method includes the additional step of manufacturing the product.

Desirably, the requests identify the typesetting information by reference to information stored in a database and the customer request is received over a global telecommunications network such as the Internet, the World Wide Web or an intranet.

Yet another embodiment of the invention provides a computer-implemented method of retrieving information. The method includes storing first relationship information and second relationship information. The first relationship information identifies a first entity as the buyer, a second entity as the seller, and a first product as the product. The second relationship information identifies the second entity as the buyer, a third entity as the seller, and a second product as the product. Both the first relationship information and second relationship information are retrieved, however, the second relationship information is retrieved based on the identity of the seller identified in the first relationship information.

In a further embodiment of the invention, a system is used to store information about buyers and sellers of products. The system includes a database containing a plurality of relationship records. The system also includes a processor for retrieving a second relationship record based on a first relationship record, whereby the buyer entity identified in the second relationship record is the same entity as the seller identified in the second relationship record, and whereby the product identified in the second relationship record is related to the product identified in the first relationship record. Preferably, the database is stored at a central location on a single server.

In yet a further embodiment, a system is maintained by an administrator and used to store information about the relationships between buyers and sellers. The system includes data representing an agreement by a middle entity to provide a product to a bottom entity in exchange for compensation and an agreement by a top entity to provide a related product to the middle entity in exchange for compensation, none of the entities being the administrator. They system also includes a processor for utilizing the data to process a request for the product from the bottom entity to the middle entity such that the request generates a request for the product from the middle entity to the top entity. Desirably, the data further comprises another agreement by another entity to provide the product to the top entity.

In still another embodiment, a computer-implemented method is provided for retrieving information relating to a request for personalized products. The method includes storing an agreement by a second entity to provide a product to a first entity and storing an agreement by a third entity to provide the product to the second entity. The first entity requests the product from the second entity such that the request includes modifying the product in accordance with personalization information provided by the first entity. The personalization information is particular to the first entity. A request for the product from the second entity to third entity is then generated. The request is generated based on the stored agreements and includes the personalization information. The personalization information may be an image.

Another embodiment provides of a computer-implemented method of selling products over the world-wide web. It includes providing a database which centrally stores agreements between a plurality of members selling a product. It also includes: sending a web page from a first member to a customer, the web page identifying a product that is the subject of one of the agreements of the database; receiving a request for the product from the customer, the request including an image provided by the customer; generating a first purchase order from the first member to a second member based on a second agreement stored in the database, the purchase order including the image; and generating a second purchase order from the second member to a third member based on a third agreement stored in the database, the purchase order including the image. The method may also include the step of storing the agreements by sending information relating to the agreements to the database via the Internet.

Although all of the methods speak of products, it should be understood that a product as used in the context of this specification may also refer to a service or a product and a service.

### BRIEF DESCRIPTION OF THE DRAWINGS

FIG. 1 is diagram of a system in accordance with one embodiment of the invention.

FIG. 2 is a diagram of a Reseller Database in accordance with one embodiment of the invention.

FIG. 3 is a diagram of a Relationship Table in accordance with another embodiment of the invention.

FIG. 4 is a diagram of a Relationship Table and a Transactional Table in accordance with yet another embodiment of the invention.

FIG. 5 is a screen display in accordance with one embodiment of the invention.

FIG. 6 is a screen display of a list of products ordered by a customer in accordance with a further embodiment of the invention.

FIG. 7 is a screen display of a receipt page in accordance with a further embodiment of the invention.

FIG. 8 is a screen display of an order status page in accordance with a further embodiment of the invention.

FIG. 9 is a screen display for entering personalization information in accordance with yet a further embodiment of the invention.

FIG. 10 is a screen display for locking and unlocking aspects of personalization information in accordance with yet a further embodiment of the invention.

FIG. 11 is a screen display for entering personalization information after the information contained in the screen display of FIG. 10 has been processed.

FIG. 12 is a screen display for entering personalization information, including a graphical logo, in accordance with yet a further embodiment of the invention.

FIG. 13 is a screen display for locking and unlocking aspects of personalization information, including a graphical logo, in accordance with yet a further embodiment of the invention.

FIG. 14 is a screen display for entering personalization information after the information contained in the screen display of FIG. 13 has been processed.

### DETAILED DESCRIPTION OF THE PREFERRED EMBODIMENTS

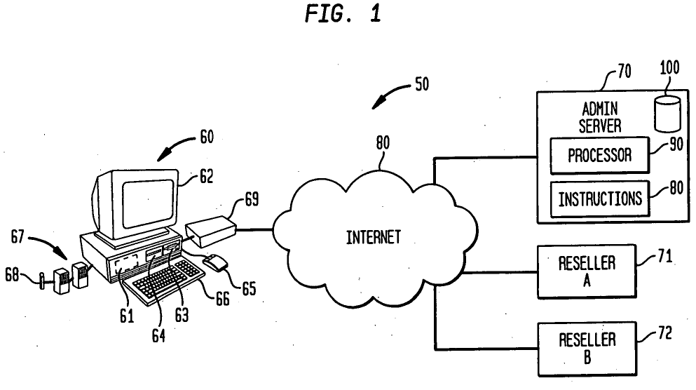

As shown in FIG. 1, a system 50 in accordance with one embodiment of the invention comprises a network of computers such as end user personal computer 60 which communicates with web servers 70-72 via Internet 80. Although only a few computers are depicted in FIG. 1, it should be appreciated that a typical system can include a large number of connected computers. Preferably, end user computer 60 is a general purpose computer having all the internal components normally found in a personal computer such as, for example, central processing unit (CPU) 61, display 62, CD-ROM 63, hard-drive 64, mouse 65, keyboard 66, speakers 67, microphone 68, modem 69 and all of the components used for connecting these elements to one another. End user computer 60 communicates with the Internet 80 via modem 69. End user computer 60 may comprise any work station capable of processing instructions and transmitting data to and from humans and other computers, including PDA's with modems and Internet-capable wireless phones.

Web servers 70-72 contain hardware for sending and receiving information over the World Wide Web, such as web pages or files. The web servers 70-72 may be typical web servers or any computer network server or other automated system capable of communicating with other computers over a network, including the Internet, wide area networks or local area networks. For example, the system described above in connection with end user computer 60 may also function as a web server.

Particularly, administrative web server 70 contains a processor 90, a set of instructions 80 which are executed by processor 90, and a variety of data such as Reseller Database 100. Preferably, the instructions 80 are stored as a program on the hard drive of the administrative server 70 and contain routines, such as functions and methods, for handling input/output and for accessing and manipulating the data in the database. The routines of the program are explained in more detail below.

Reseller Database 100 stores agreements and transactions between the entities served by the system 50 (hereafter “members”) and the public. Preferably, the database is relational and contains multiple tables containing multiple records.

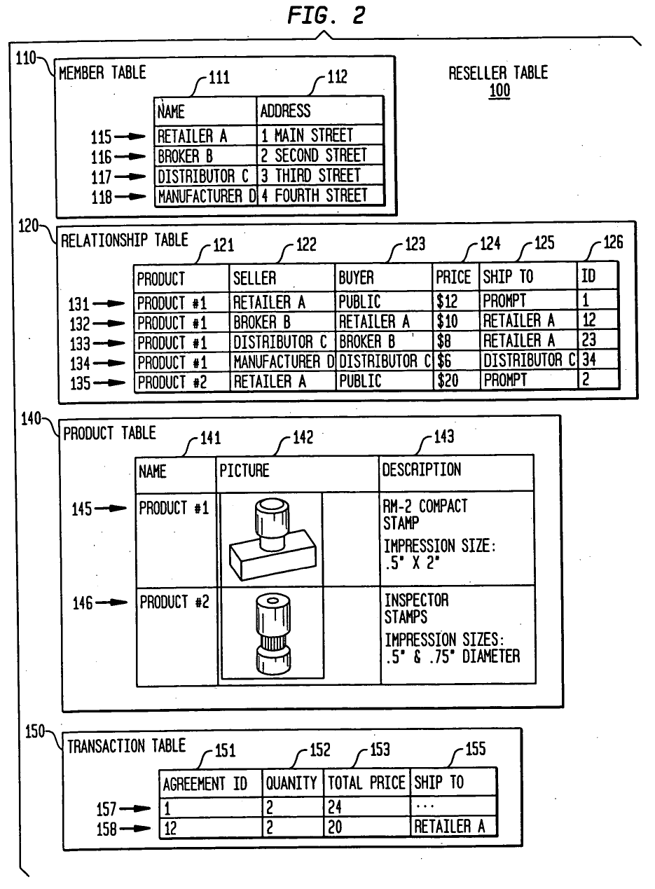

As shown in FIG. 2, one of those tables is Member Table 110. Member Table 110 stores information about the individual members. Each member occupies a record in the Member Table and the record includes the member's name 111 and biographical information such as the member's address 113, the nature of its business and the like. By way of example, record 115 of Member Table 110 may contain information about a company known as “Retailer A” whose name is stored in Name field 111 and whose address of 1 Main Street is stored in Address field 112. Exemplary records 116-18 correspond with three different companies having three different names (such as Broker B, Distributor C, Manufacturer D) and addresses.

Information regarding relationships between the members is also stored in Reseller Database 100. These relationships may include agreements to buy and sell products on pre-identified terms. For exemplary purposes only, this embodiment shall be discussed in the context of the following hypothetical business arrangement. Retailer A is a retailer that sells personalized products on-line by mail and one of those products shall be considered to be a stamp known as Product #1. Retailer A sells the product to the public for $12. As is typical for retailers, Reseller A does not manufacture Product #1, but, rather, buys Product #1 for $10 from another company, Broker B. Broker B, in turn, may simply be a broker for Product #1 and arranges delivery for Product #1 to Retailer A from a distributor, Distributor C, for which Broker B pays Distributor C $8. Distributor C, in turn, buys Product #1 from the ultimate manufacturer, Manufacturer D, for $6.

Relationship Table 120 of Reseller Database 100 stores this contractual information in records 131-134. Each record contains a number of fields such that Product field 121 identifies the product, Seller field 122 identifies the seller, Buyer field 123 identifies the buyer, Price field 124 identifies the price, and Ship To field 125 contains information about where the product should be shipped. For example, the relationship between Distributor C and Manufacturer D is stored in record 134 such that the Product field 121 has the value “Product #1”, seller field 122 has the value “Manufacturer D”, buyer field 123 has the value “Distributor C”, price field 124 has the value $6, and Ship To field 125 has the value “Distributor C” because the product is shipped from Manufacturer D to Distributor C. The ID field 126 contains a value that uniquely identifies that particular relationship. The other relationships are similarly stored in Agreements Table 120.

Some companies are not only buyers, but they are also sellers. Relationship Table 120 stores both aspects. For example, the exemplary agreement between Broker B and Distributor C is stored in record 133 with the following values:

| Product | Seller | Buyer | Price | Ship To | ID |
|---|---|---|---|---|---|
| 121 | 122 | 123 | 124 | 125 | 126 |
| Product #1 | Distributor C | Broker B | $8 | Retailer A | 23 |

It will be noted that the Ship To field contains a different value than the buyer field, which reflects the fact that Broker B never actually receives the product. Rather the product is shipped directly from Distributor C to Retailer A, even though Broker B is paying the Distributor C the price of $8.

It is not always possible to know, in advance, the value of every field before a product is ordered. For example, while Retailer A knows that it will charge the public $12 for Product #1, it does not know until the time-of-sale who the purchaser is or where it will be shipped. In this instance, Relationship Table 120 contains codes which identify the missing information, such as:

| Product | Seller | Buyer | Price | Ship To | ID |
|---|---|---|---|---|---|
| 121 | 122 | 123 | 124 | 125 | 126 |
| Product #1 | Retailer A | Public | $12 | Prompt | 1 |

whereby “Public” means that any member of the public may be a buyer and “Prompt” means that system will prompt the buyer for the information at the time of sale. Accordingly, the system allows a retailer with a standard set of retail prices to store its retail prices in the database for public viewing even though the buyer's identity is unknown. Moreover, rather than defining the potential buyer as the entire public, other codes could be used to limit the potential buyers to a subset of the public or particular class of entities (such as “stamp retailers”).

Reseller Database 100 also contains a table for centrally storing information about the products. Products Table 140 contains records whereby each record contains a Name field 141 for storing the name of the product, a Picture field 142 for storing a picture and a Description field 143 for storing a textual description of the product. Records 145 and 146 of FIG. 2 illustrate exemplary values.

Reseller Database 100 further contains another table for recording transactions facilitated by the system, namely Transaction Table 150. Records in the Transaction Table contain a reference to the agreement under which the transaction was made as well as fields devoted to the particulars of the transaction, such as the number of products sold, the total price and where the product should be shipped. These values are stored in the following respective fields: Relationship ID 151, Quantity 152, Total Price 153, and Ship To 155.

Preferably, Reseller Database 100 stores its information using conventional database storage products and query formats, such as products by Oracle, PICK and Universal. The system may conduct the searches using SQL. However, the database may contain information in any format, such as XML. Thus, a “record” refers to any item, or collection of items, of information in the database.

In accordance with the embodiment of the system described above, the invention may be operated as follows.

User 60 visits a web site relating to Retailer A and hosted by administrator server 70 and requests to see a list of all the products carried by the retailer.

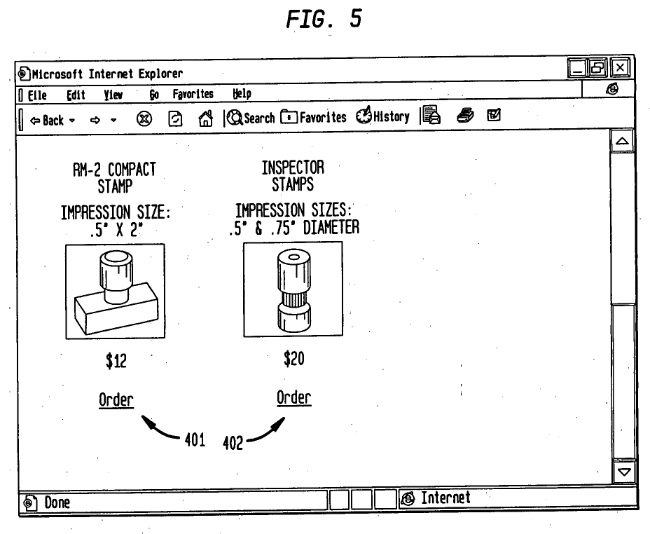

Pursuant to instructions 80, processor 90 searches Relationship Table 120 for all records listing the particular retailer in Seller field 122 and the string “Public” in the Buyer field 123. A list of matching products is compiled and shown to the potential customer using the information contained in the Product Table 140, namely the product's name, picture and description. The price is obtained from the Price field 124 of Relationship Table 120 and is also shown to the user. Using the foregoing example, records 131-32 of Relationship Table 120 and records 145-46 of Product Table 140 may have been pulled and displayed on a web browser such as shown in FIG. 5.

When the user orders the product, the selected product is matched to the particular relationship. In the embodiment shown in FIG. 5, the product information is shown separately for each relationship, i.e. product 401 shown in FIG. 5 corresponds with relationship record 131 of FIG. 2 and product 402 shown in FIG. 5 corresponds with relationship record 135 of FIG. 2. Accordingly, the relationship may be found simply by allowing the user to click on one of the pictures and sending this information to administrative server 70. In a manner well known to those of ordinary skill in the art, other information would also be collected such as the quantity desired, how payment will be made and where the product should be shipped.

The order is then stored in Transaction Table 150 by creating a record containing: the relationship pursuant to which the transaction was made, the quantity of product, the total amount paid, and where the product should be shipped. Using the foregoing example, if user 60 purchased 2 units of Product #1, record 157 will contain the following values: Relationship ID field 151 contains a value equal to the value contained in ID field 126 of record 131; Number Of Products field 152 contains the value 2; Total Price field 153 contains the value $24; and Ship To field 155 contains the user address.

Instructions 80 next determine whether the seller buys the product from another member of the system. One manner in which this search may be conducted is for processor 90 to search for all records in the Relationship Table 120 where the name in Buyer field 123 matches the seller, and the product in Product field 121 matches the product. Using the foregoing example, processor 90 will pull record 132 of Relationship Table 120 because the buyer in record 132, “Retailer A” matches the seller, also “Retailer A”, from the previous transaction record 131.

If a record in Relationship Table 120 is found showing that the current seller is also a buyer of the same product, then the system automatically generates a new transaction using information already stored in the system. One manner in which this may be done is to create a new record in Transaction Table 150 using the information from the latest record found in the Relationship Table 120 and the previously stored record in Transaction Table 150. By way of the foregoing example, instructions 80 store a new record 158 in Transaction Table 150 such that the quantity 152 is the same as the quantity from the previous transaction (record 157) and the remaining information (Agreement ID 51, Quantity 142, Total Price 153 and Ship To 155, as applicable) are all pulled and computed from the record just found in Relationship Table 120 (record 132).

Once the new transaction is stored, the process repeats, namely, processor 90 continues to search Relationship Table 120 to see if the seller in the latest transaction is also listed as a buyer for the same product. If so, a new transaction is generated and the processor searches Relationship Table 120 again to see if the latest seller is also a buyer of the same product. Records 133-134 would thus be pulled and new transaction records created accordingly. In one embodiment, the system stops searching when it is unable to find any record of any entity selling that particular product to the then-current seller. There is substantially no limit to the length of the chain of transactions generated by a single order.

During or after the records are added to the Transaction Table 150, notifications of the transactions are sent to the members of the system so that the orders can be filled. Preferably, the system sends the information in a format consistent with the members' own product management software so that the orders can be filled with minimal human intervention. However, the notification may be made in other ways, such as by sending the members an e-mail each time they are involved in a transaction or periodic hard-copy reports.

Accordingly, when a member orders a product, the system automatically arranges a transaction based on previously-arranged business terms.

In yet another embodiment, the system also handles personalized products. For example, the end-user may upload a personalized image which the user wishes to appear on the products, such as the impression on a stamp. One manner in which this may be carried out is to add a Personalization field 2128 to the Relationship Table 2120 as shown in FIG. 4. If the field contains the value “Picture”, then the system will prompt the buyer to upload a picture at the time the product is ordered.

The uploaded picture is then stored in the personalization field 2152 of a new record 2157 in Transaction Table 2150. When a member is informed of the transaction, the system provides the member with a pointer or reference to the stored image. Accordingly and advantageously, the image is not sent to entities that do not need it.

Preferably, all of the images are converted and stored in a single format. Prior art systems may have required a single company to maintain and use a different image converter for each imaging format used by its customers and vendors. In fact, the same image may have been converted to different formats many different times as the purchase order was passed up the chain. By storing all images in the database in a single format, the members need only know how to convert the image from one format—the system's—into their own. Indeed, the system preferably stores the member's particular imaging format in the respective record of Member Table 110 and automatically performs the conversion when the member accesses the image.

It is not necessary for the personalized information to be limited to images. The personalized information may also include information particular to the customer, like their name and address. Thus, the system can accommodate requests for product modifications that are not pre-stored in the system. In other words, while systems may be pre-configured for well-known options such as product color and size, the system of the invention is capable of automatically creating a cascade of purchase orders containing unanticipated product modifications (like the exact image to be placed on a stamp) particular to the ultimate customer.

The ability to transfer personalized information capitalizes on yet another advantage of the invention: nearly all of the data can be transmitted electronically. By electronically storing and passing along personalization information, it is not necessary to recreate typesetting or design at different levels of the chain of distribution.

The features of personalization, uploading of images and pipelining purchase orders work together to provide yet another advantage of the invention, namely to ability to order accurate typesetting on-line. In another embodiment of the invention, the customer uploads a picture, graphic file or other information representing typesetting. For example, a typeset image may be created on-line as part of the process of a selecting a particular stamp, whereby the typesetting represents the impression made by the stamp. The system then converts the typesetting information into either a default graphic file format or the format needed for by the manufacturer to create the product. The typesetting and design, which was created by the end user, is then centrally stored in the database and made available to the members of the system as described above.

Because the end user has done their own personalization and the manufacturer gets the graphic file from the database regardless of how many resellers the order may be passed through, the chance of error is greatly diminished. The ability to upload and centrally store typesetting information provides more advantages than simply decreasing errors. It saves time because it is not necessary to re-typeset and design the personalization by the manufacturer. Moreover, it avoids the labor required to pass that information on through reseller channels to the manufacturer. The accuracy of the automated system provides for streamlined operations and faithful reproductions of the end users design.

The typesetting-related aspect is not limited to stamps. Rather, it can be used with any typesetting-related product such as printed items or signs. For example, the invention could be used to order advertising specialties such as printed plates and the like.

The personalization information may also be sent back to the user for confirmation or information purposes. It is well known in the art to provide on-line customers with a list of the products they are purchasing, such as a “virtual shopping basket.” However, the present invention provides the additional advantage of showing the personalization information in a list of products ordered by the user. This information could also be provided during the notification process discussed above.

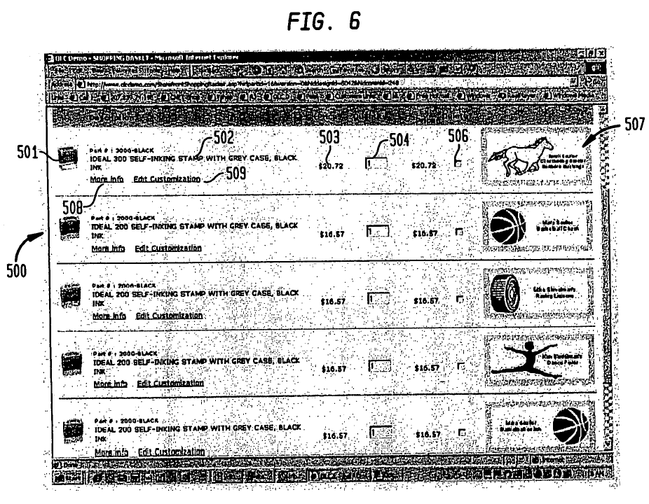

As shown in FIG. 6, after the user is finished placing their order or upon the user's request, administrative server 70 sends a web page 500 containing a list of all of the products ordered by the customer. By way of example, each item in the list includes: a picture 501 of the product, a description 502, the quantity 504, an option 506 to delete the product from the order, an option 509 to modify the personalization and an option 508 to obtain further information. Each item in the list further includes not only a picture of the product, but also a graphic 507 which represents the personalization information.

The display of personalization information to the user has a number of advantages. On the outside, all of the product pictures 501 (in this case, stamps)may look the same. Therefore, while a product picture conveys useful information about the product being ordered, the display of the personalization information 507 associated with each product allows the users to further differentiate the products in the order. Displaying the personalization information 507 also has the advantage of making the option 509 to modify the personalization more helpful.

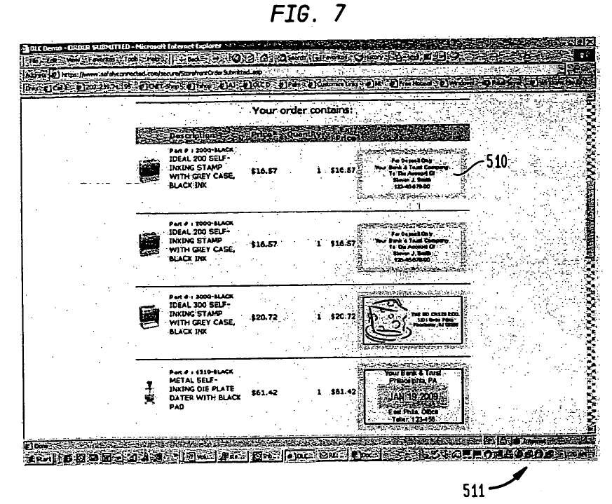

The display of personalization information may be used in product lists as well. For example, personalization information 510 may be listed on a receipt page 511 as shown in FIG. 7 and, thus, helps a user insure a proper accounting record of the purchases.

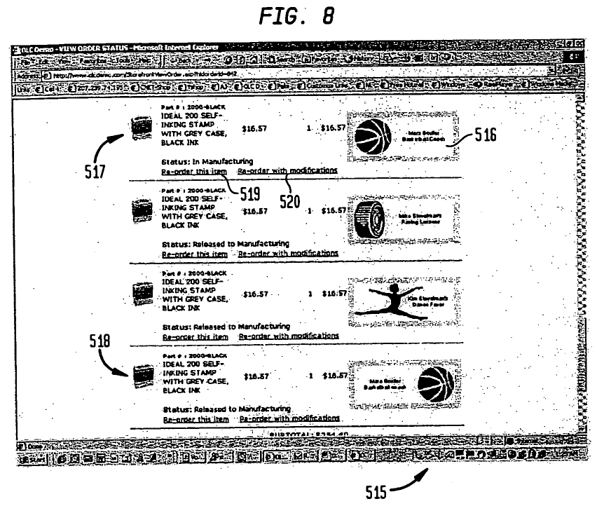

Personalization information 516 may also be shown on an order status page 515 as shown in FIG. 8. The personalization is used to preview the order status. Without the personalization image, it may be difficult to know which item is referred to in the order status. For example, the two different “Mara” items 517 and 518 have different statuses: one is “in manufacturing” and the other is “released to manufacturing”, respectively. The order status page also provides options 519 and 520 to reorder the product (one as is and the other with modifications, respectively). Since the preview is shown on this page, it is easy to select the correct personalization. In another embodiment, the personalization information 507 may also be displayed in textual form.

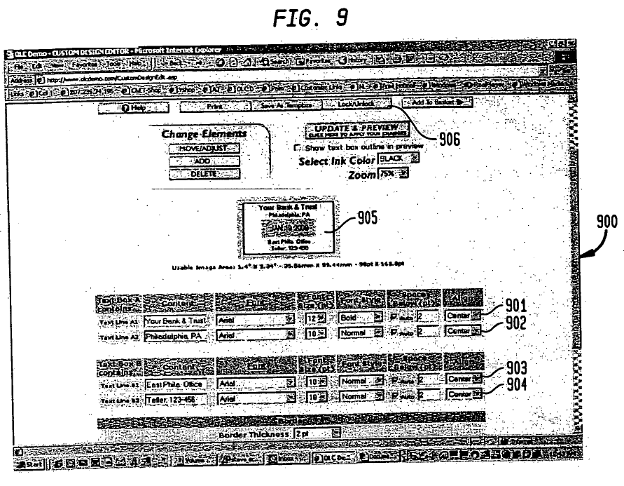

One manner of uploading the personalization information and preventing unauthorized or unintended changes is shown in FIGS. 9-14. When making personalizations that need to be repeated, it is often preferred that fields that should not be changed be locked to prevent accidental changes in the design format. Personalizations often need to fit certain requirements for uniformity from government agencies, local requirements and corporate requirements. Large companies often require that use of the company logo in personalizations be uniform so that the company look is the same from product to product. Personalization may also need to conform to requirements for electronic scanning devices, a size to fit a form, or any other reason to keep design criteria the same. In addition, a user may simply wish to prevent previously-entered information from being changed in order to prevent inadvertent errors.

FIG. 9 illustrates a web page for entering personalization information for a stamp. The page displays personalization criteria 901-904 for the stamp. In this example, each criteria includes certain aspects such as the content (e.g. the text to be displayed), font, font size, font style, position and alignment.

In FIG. 9, the various aspects of criteria 901-904 are currently unlocked, i.e. the values of the aspects can be changed by the user. Accordingly, the user may change all of the text and other information contained in personalization information 905.

However, there may be a reason to prevent certain fields from being changed, such as the company name and address contained in “Text Line A1” field 901 and “Text Line A2” field 903, respectively. For example, if that information remains constant across a large number of stamps, the user may want to prevent inadvertent changes to that information. On the other hand, the other fields may change from stamp to stamp, such as the particular company office and employee identification number contained in “Text Line B1” criteria 903 and “Text Line B2” criteria 904. Indeed, only some of the aspects may change from stamp to stamp. For example, the font size, style, and position of the company office and employee identification may need to stay the same even though the actual text or content may change.

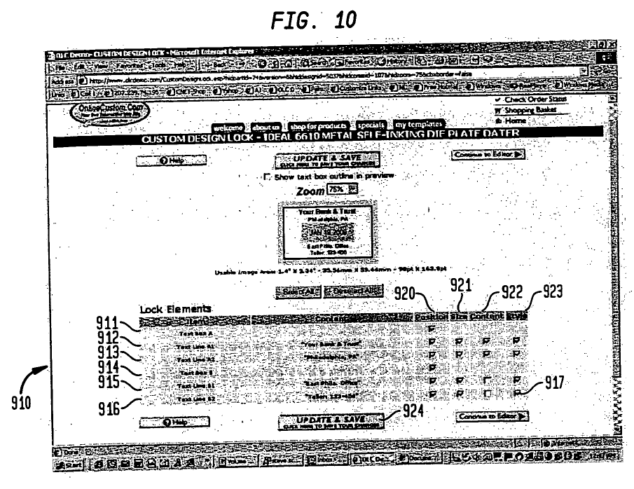

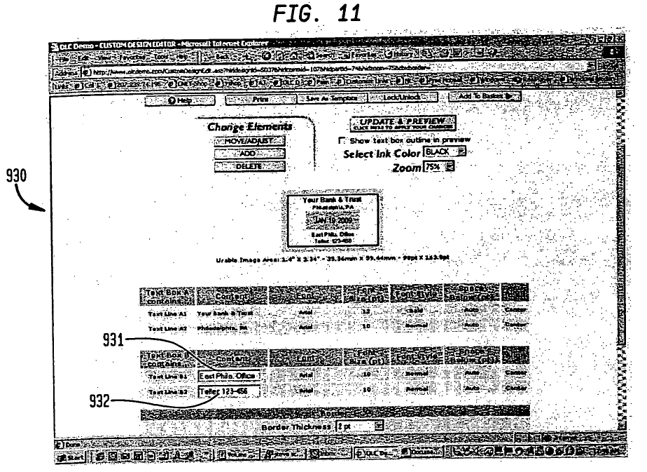

Accordingly, when the user selects the lock/unlock button 906, administrative server 70 sends a web page to the user which lists the criteria and aspects requesting which may be locked or unlocked. An example of such a web page 910 is shown in FIG. 10. The page lists the various criteria 911-916 as well as aspects of the criteria including position 920, size 921, content 922 and style 923. For each aspect, the user is allowed to choose (such as by clicking checkbox 917) whether the particular aspect is locked or unlocked. In the example shown in Page 910, the only criteria aspects that are not locked are the content aspects 922 of Text Line B1 criteria 915 and Text Line B2 criteria 916. The other aspects of those criteria, such as position 920 and size 921, are locked. When the “Update and Save” button 924 is clicked, the page is sent to administrative server 70 and the server stores the information.

The next time the user accesses the personalization page, the user will not be able to change the locked aspects of the personalization criteria unless the user goes back to web page 910 and unlocks the aspects again. For example, as shown in page 930 in FIG. 11, the only criteria aspects that are capable of accepting information via the page are textboxes 931 and 932, which correspond with the content of Text Line B1 and Text Line B2.

Preferably, the page which permits the locking and unlocking of information is always available to every user within an orgranization. Rather, it may be limited to only certain people within an organization, such as the system administrator or others with access to the personalizations of the user. In such an embodiment, different users would be provided with different logins or passwords, and those logins or passwords are used to determine whether a user has the ability to lock or unlock all or some of the aspects.

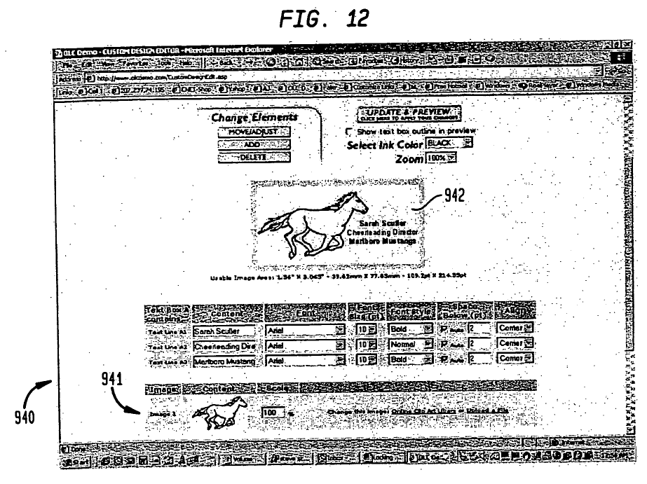

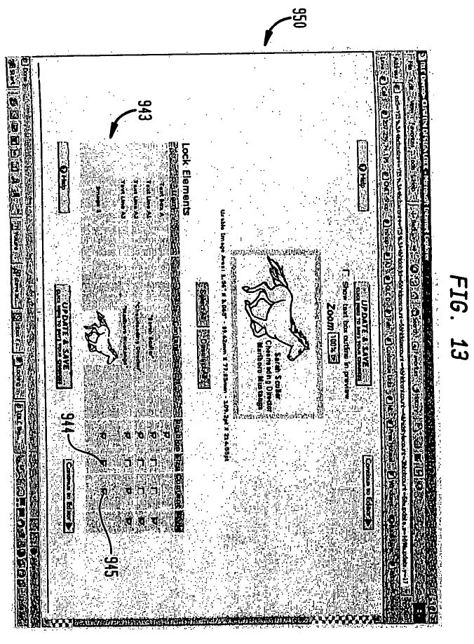

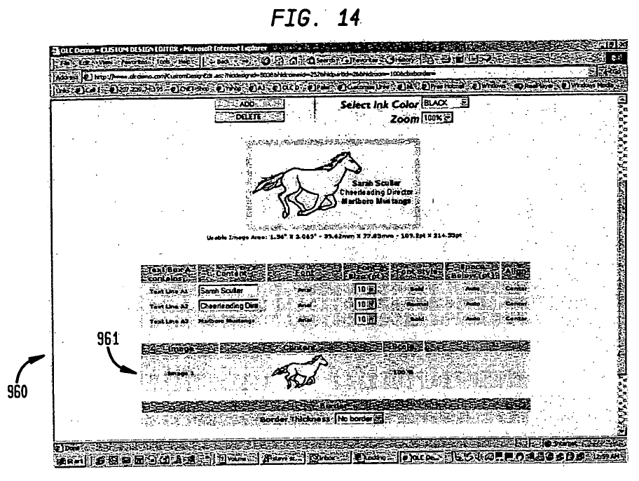

It is not necessary to limit the locking/unlocking feature to text. For example, FIG. 12 illustrates a web page 940 with criteria 941 which allows the file and size of logo 942 to be changed, FIG. 13 illustrates a web page 950 which allows the user to lock the logo field including the file (content 945) and size 944, and FIG. 14 illustrates a web page 960 with all of the logo criteria 961 being locked.

Nearly any aspect of any personalization criteria may be locked. By way of example, other aspects may include color, quantity, paper stock or any other variable that would a user or organization would like to lock.

The system is also flexible enough to handle many different pricing schemes. Rather than storing fixed prices in field 124, the field may contain a formula. A commission may be represented as a percentage multiplied by the Total Price 153 stored in the corresponding transaction record.

Moreover, the prices can be set and controlled by the database administrator. This is particularly advantageous when the system is primarily directed to the sale of the database administrator's goods.

On the other hand, the system may be configured to allow the members to create and store their own agreements. In this embodiment, instructions 80 include routines which allow a member (“the proposing member”) to enter a proposed relationship with another member. If the other member implicated by the proposed relationship provides the system with confirmation, then the system will store the relationship in the system. Accordingly, members are allowed to store agreements without intervention by the entity operating the administrative server 70. Resellers can negotiate independently to determine their prices, terms and conditions but, when their information is stored in the system's database, the resellers still obtain the advantages of participating in the system.

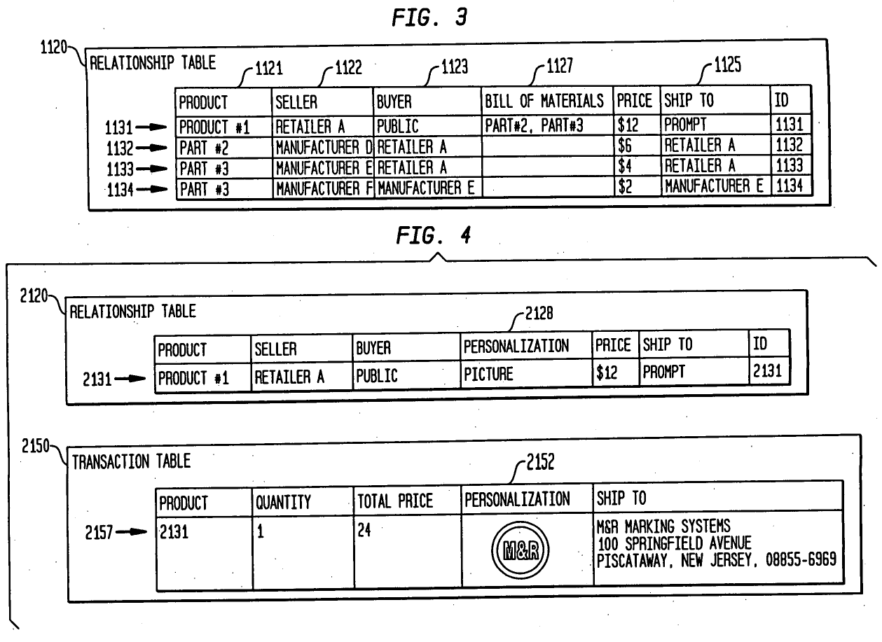

Yet another advantage of the invention is that it is not limited to complete products. Most manufacturers purchase one or more of a product's parts from different parties. The system may be configured such that purchase orders for products automatically generate purchase orders for the constituent parts. For example, as shown in FIG. 3, the Relationship Table 1120 may have a Bill of Material field 127. In accordance with the operation discussed above, when the processor 90 pulls a record from Relationship Table 120, it checks the Bill of Material field 1127 to see if the sale of the product involves the sale of individual parts as well. If Bill of Material field 1127 is not null, then instead of checking whether the seller is also listed as a buyer in a different relationship record for the entire product, the system checks whether the seller is listed as a buyer for the individual parts. If so, i.e., if the seller of the product is also a buyer of the parts, then the process proceeds with the products/parts listed in the Bill of Material field 1127 in the same manner as described above in connection with Product #1.

By way of example, when record 1131 is pulled from Relationship Table 1120 of FIG. 3, the system checks the value of Bill of Material field 1127. Because Bill of Material field 1127 lists two different products, the system no longer checks to see if Retailer A buys Product #1 from another member. Rather, the system checks Product field 1121 of Relationship Table 1127 for records indicating that Retailer A buys the products contained in the Bill of Material field 1127, namely Part #2 and Part #3, from other members. For example, the system will pull record 1132 and record the sale of Part #2 from Manufacturer D to Retailer A as a transaction. Moreover, when the system pulls record 1133 showing that Manufacturer E sells Part #3 to Retailer A, the system will check to see if Manufacturer E buys Part #3 from another member. In response, the system will pull record 1134 showing that Manufacturer F sells Part #3 to Manufacturer E. Alternatively, rather than storing the Bill of Material field in the Relationship Table, the field may be added to Product Table 140, so that the system checks the Product Table for parts information.

Accordingly, an order for a single product may generate multiple distribution streams of parts. Indeed, some of the parts may come from the same company that requested the product. For instance, this may occur when a manufacturer sells a complete product but only makes some of the parts. In such a case, the manufacturer may list the parts that it provides in the database for internal accounting purposes.

Another advantage is that companies can sell more products and services than they would normally have access to or in inventory because they can make pre-arranged transactions that are automatically implemented without their intervention. This allows the members to seamlessly offer via the Internet, in-store, mail order or through any other barter or sale transaction a wide range of products and services. Because products can be shipped directly from one level of a chain of distribution to non-contiguous levels, the system also permits a consumer to order product from a reseller even if the reseller does not have the product on hand. The system also allows the order to be seamlessly passed on to other resellers who can fulfill the product orders either directly or indirectly back through the reseller.

Another advantage of the invention is the potential savings in shipping costs. For example, if a product is sold unchanged through three entities before going from the manufacturer to an end user, then rather than shipping that unit four different times the manufacturer may simply ship the unit directly to the end user. One method of implementing this alternative would be to place a code in Ship To field 125 in Relationship Table 120 that indicates that the value contained in Ship To field 155 of Transaction Table 150 should be passed up the chain of transactions. This is not only advantageous to resellers, who do not need to participate in the physical distribution of the product and are thus freed of the expense of receiving and making shipments, but it is also advantageous to the customer because shipments will often be quicker and less costly.

Preferably, the system does not provide members with access to transactions in which the member is not a direct buyer or seller. Often times, a broker will not want a manufacturer to know the identity of the broker's customers lest the manufacturer sell around the broker. Accordingly, although Broker B will be notified of its transactions with Retailer A and Distributor C, Broker B will not be notified of the transactions which are upstream or downstream of those transactions. In other words, transactions that do not directly involve a member are transparent to that member even if that member is somewhere in the chain of distribution of the product. This transparency has the added advantage of allowing consumers to buy products on-line and remain anonymous to every entity in the chain of distribution other than the retailer operating the web site. Orders can be passed from the bottom of the chain of distribution, through the middle and to the top, both automatically and substantially anonymously.

This transparency can extend to the personalized information provided by the customer. It is not necessary to allow all of the members of the chain of distribution to have access to the personalized information. Rather, there are instances in which only those entities which require the information in order to manufacture the product should have access to the personalized information. Accordingly, in another embodiment of the invention, the agreements table may be modified to include fields specifying whether a member has full, partial or no access to the personalized information such as the image contained in personalization field 2152 of FIG. 4. If the member has only partial access, then the member can see either portions of the image or, alternatively, the entire image at low resolutions. The low-resolution images are intended to allow the member to see the image but still prevent the member from using the image to make a product (due to the low quality of the image).

A further advantage of the invention is that the same product information can be used by different parties. Because product information is centrally stored in a single table, resellers are saved the expense of retyping the information provided by manufacturers. By way of example, it is common for manufacturers to sell products to distributors through brokers. The distributors, in turn, sell the product to retailers who then sell the product to the public. Each one of the entities in this chain may have a web site which lists the products they have available. If the entities choose, they may simply use the picture and description of the product stored in the products table rather than coming up with their own pictures and descriptions of the products.

The invention has numerous other advantages and alternatives. First, it allows resellers to sell products to and from each other. Second, the products contained in the system may be either controlled or not controlled by the database administrator. In other words, members are free to modify their own product information rather than requiring the human-intervention of the entity controlling the administrative server.. Third, it is not limited to “complete” channels of distribution. In other words, the system does not have to participate in every step of the channel of distribution for a particular product in order to provide a benefit to the members. Instead, it may implement only one or more portions of a channel of trade and, thus, complement prior art product ordering procedures. For example, the process does necessarily not start with the general public. It could start with any member ordering a product from any other member. Fourth, the system is not limited to products, but can also be used to offer and procure services such as labor services utilizing contractors, subcontractors and sub-subcontractors. Fifth, the system may be distributed or operate in parallel with other similar systems, such that it has one or more database servers, one or more database administrators, and one or more web servers. Sixth, by breaking a chain of distribution into discrete relationships, the system can handle extremely complex webs of relationships.

It is also not necessary for the administrative server 70 to host the reseller's individual web sites. For example, as shown in FIG. 1, resellers may host their own web sites on web servers 71-72, and send the product orders to administration server 70 via Internet 80.

Although the invention can be implemented using any known database system and language, yet another embodiment of the invention is set forth in Appendix A (incorporated herein by reference). The following fields of the database illustrated in that Appendix are similar to the fields shown in FIG. 2 above:

| | Appendix A |
|---|---|
| Member Table.Name 111 | Member table, user_id field |
| Relationship Table.Product 121 | Manufacturer Accepted Part and/or |
| | Manufacturer Accepted Products |
| | Reference tables, part_id field |
| Relationship Table.Seller 122 | Manufacturer Accepted Part and/or |
| | Manufacturer Accepted Products |
| | Reference tables, src_id field |
| Relationship Table.Buyer 123 | Manufacturer Accepted Part and/or |
| | Manufacturer Accepted Products |
| | Reference tables, mfr_id field |
| Relationship Table.Price 124 | Manufacturer Accepted Part and/or |
| | Manufacturer Accepted Products |
| | Reference tables, src_price |
| | field |
| Product Table.Name 141 | Part table, part_id field |
| Product Table.Picture 142 | Part table, img_url field |
| Product Table.Description 143 | Part table, brief_descr field |
| Transaction Table.Agreement ID | Order Header table, mfg_id and |
| 151 | ord_id fields |
| Transaction Table.Quantity 152 | Order Line Item table, ord_qty |
| | fields |
| Transaction Table.Total Price | Calculated multiplication of |
| 153 | Order Line Item Table, ord_qty |
| | and unit_price fields |
| Transaction Table.Ship To 155 | Order Header Table, fields |
| | beginning “Sold_To” |
| Transaction Table.Personalization | Filename of image is stored in |
| 2152 | Image Table in img_src field. |
| | The design_id field of the Order |
| | Line Item table points to the |
| | appropriate record of the Image |
| | table. |

In operation, the modules set forth in the Appendix operate as follows: if Company A sells Product #10 to Company B who sells Product #10 to the general public, then the “sp_pipeline_mfr add” module is utilized twice to add Company A and then Company B to the database; the “sp_pipeline_mfr_product_add” module is then utilized to add Product #10 to the list of products which Company A sells on the system; in order to represent the fact that Company A has agreed to sell products to Company B, an “organization” is created by utilizing the “sp_pipeline_org_add” module (the organization potentially having the identifier “Company A to B org”); the “sp_pipeline_org_product_add” module is then utilized to identify the products that are sold within that organization, the price and other terms (e.g. the module would be utilized to identify Product #10 and the compensation agreed to be paid by Company B to Company A for the product); another organization is created to represent Company B's sale of Product #10 to the pubic by again utilizing the “sp_pipeline_mfr_product add”, “sp_pipeline_org_add” and “sp_pipeline_org_product add” modules; and when a member of the public does ultimately order Product #10 from Company B and Company B approves the order, the system utilizes the recursive algorithms of the “BOrder.cls” object to find organizations implicated by the order and pass the order information from one organization to the next. The “BProd.cls” object is utilized to provide product and line information for the order such as shipping info and details about the product being ordered. The “BOrg.cls” object is utilized to notify the companies about the transactions. Preferably, credit checks are performed each time an order is made from one member to another.

Unless stated to the contrary, use of the words such as “including,” “containing,” “comprising” and the like, means “including without limitation” and shall not be construed to limit any general statement that it follows to the specific or similar items or matters immediately following it.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims.

What is claimed is:

1. A method of displaying products comprising:
receiving order information relating to a first and second product ordered by a user wherein the first product is personalized, the personalized first product displaying personalization information provided by the user, and
sending visual information relating to the personalized first product and the second product to the user for display on a computer,
the visual information displaying an image of the personalization information reflecting the manner in which the personalization information will be displayed by the first product, and other information relating to the personalized first product.

2. The method of claim 1 wherein the step of sending includes providing the user with an option to edit the personalization information.

3. The method of claim 1 wherein the second product also displays personalization information provided by the user and wherein the visual information also displays an image of the personalization information associated with the second product which reflects the manner in which the personalization information will be displayed by the second product.

4. The method of claim 3 wherein the personalization information of the first product is different from the personalization information of the second product.

5. The method of claim 3 wherein the personalization information of the first product is the same as the personalization information of the second product.

6. The method of claim 1 wherein the step of sending includes providing the user with an option to delete the product from the order.

7. The method of claim 1 wherein the personalization information comprises text or graphics to be affixed to the product.

8. The method of claim 1 wherein the other information relating to the product includes a description of the product.

9. The method of claim 8 wherein the other information includes the quantity of product ordered.

10. The method of claim 1 wherein the other information includes a picture of the product.

11. The method of claim 10 wherein the picture omits the personalization information.

12. The method of claim 1 wherein the visual information is included in a receipt.

13. The method of claim 1 wherein the visual information is sent in response to a request from a user for the status of a product order.

14. The method of claim 1 wherein the step of sending visual information includes sending a web page containing the visual information.

15. The method of claim 14 wherein the step of receiving includes first sending the user a web page allowing the product to be ordered and then receiving an order request for the product via the Internet.

16. The method of claim 1 wherein the visual information is included in a virtual shopping basket.

17. A method of providing a virtual shopping cart to a user comprising:
receiving a plurality of products ordered by a user, the products including personalization information in the form of text or graphics to be affixed to the products,
sending a web page in the form of a shopping basket to the user, the web page listing at least two of the products ordered by a user, the list including a description of each product and, adjacent to the description, a graphic of the personalization information for the product.

18. The method of claim 17 wherein the web page includes a picture of the product.

19. The method of claim 18 wherein the picture excludes the personalization information.

20. The method of claim 19 wherein the web page includes the quantity of product ordered.

21. A system for providing a virtual shopping cart to a user comprising:
a processor for implementing instructions,
the instructions including receiving order information relating to a first and second product ordered by a user wherein the first product is personalized, the personalized first product displaying personalization information provided by the user, and sending visual information relating to the personalized first product and the second product to the user for display on a computer, the visual information displaying an image of the personalization information reflecting the manner in which the personalization information will be displayed by the first product, and other information relating to the personalized first product.

22. The system of claim 21 wherein the processor and instructions are contained in a web server.

23. A system for displaying products comprising:
receiving order information relating to a first and second product ordered by a user wherein the first product is personalized, the personalized first product displaying personalization information provided by the user, and
sending visual information relating to the personalized first product and the second product to the user for display on a computer,
the visual information displaying an image of the personalization information reflecting the manner in which the personalization information will be displayed by the first product, and other information relating to the personalized first product.

24. The system of claim 23 wherein the means for receiving a product ordered by a user includes means for receiving a list of products to be personalized with personalization information, whereby the personalization information for at least a portion of the products on the list is different for each product.

25. The system of claim 24 wherein the visual information includes the personalization information for each of the products in the portion.

26. A method of displaying products comprising:
receiving an order for at least two products, at least one of the products being a personalized product, the personalized product displaying personalization information provided by a user, and
sending visual information for display to the user, the information including:
an identification of both products,
an image representing how the personalization information will appear when displayed by on the personalized product, and
a price computed from the prices of the at least two products.

27. The method of claim 26 wherein the visual information is a virtual shopping car and the information is sent via the Internet.

28. A method of configuring a web page comprising:
obtaining an order from a user for a product identifying the product and personalization information to be affixed to a product, the content of the personalization information being determined by a user,
configuring a web page containing a textual description of the product, a picture of the product lacking personalization information, and an image of how the personalization information will appear on the product, and
transmitting the web page.

29. The method of claim 28 further comprising an order from the user for a second product and personalization information to be affixed to the second product, and including in the same web page: a textual description of the second product, a picture of the second product lacking personalization information, and an image of how the personalization information will appear on the second product.

30. The method of claim 29 wherein the personalization information for the first and second product are different from one another.
